(19) United States
(12) Patent Application Publication
(10) Pub. No.: US 2026/0265109 A1
(43) Pub. Date: Sep. 10, 2026

(54) PRODUCTION METHOD OF RECYCLED MATERIAL

(71) Applicant: TOYOTA JIDOSHA KABUSHIKI KAISHA, Toyota-shi (JP)

(72) Inventors: Kenji YOKOE, Toyota-shi (JP); Takanori Mahara, Toyota-shi (JP)

(73) Assignee: TOYOTA JIDOSHA KABUSHIKI KAISHA, Toyota-shi (JP)

(21) Appl. No.: 19/437,482

(22) Filed: Dec. 31, 2025

(30) Foreign Application Priority Data
Jan. 16, 2025 (JP) 2025-006017

(51) Int. Cl. C03B 5/00; H01M 10/54

(52) U.S. Cl. CPC C03B 5/005; H01M 10/54

(57) ABSTRACT

A production method of recycled material includes (a) preparing a battery material, (b) melting the battery material to create molten glass, (c) separating the molten glass from at least one selected from the group consisting of a metal material and an organic compound contained in the battery material, and (d) cooling the molten glass to create a glass material.

### CROSS-REFERENCE TO RELATED APPLICATION

This application claims priority to Japanese Patent Application No. 2025-006017 filed on Jan. 16, 2025. The disclosure of the above-identified application, including the specification, drawings, and claims, is incorporated by reference herein in its entirety.

### BACKGROUND

### 1. Technical Field

The present disclosure relates to a production method of recycled materials.

### 2. Description of Related Art

Japanese Unexamined Patent Application Publication No. 2021-9838 (JP 2021-9838 A) discloses a cathode containing an olivine phosphate compound as a cathode active material.

### SUMMARY

Battery materials, such as electrodes and so forth, include a variety of recyclable materials. Production of recycled materials, by recovering recyclable materials from battery materials, is being studied. However, there are cases in which other battery materials and so forth are intermingled into recycling materials to be recycled. There is a risk of foreign matter degrading performance of recycled materials.

An object of the present disclosure is to provide a production method for recycled materials with reduced amounts of foreign matter.

Technical configurations and functions and effects of the present disclosure will be described below. Note, however, that mechanisms of action according to the present disclosure include estimation. The mechanisms of action do not limit the technical scope of the present disclosure.

[1] A production method of a recycled material, the production method including
(a) preparing a battery material,
(b) melting the battery material to create molten glass,
(c) separating the molten glass from at least one selected from a group consisting of a metal material and an organic compound, contained in the battery material, and
(d) cooling the molten glass to create a glass material.

It is thought that metallic materials and organic compounds do not intermingle in molten glass. Therefore, it is anticipated that melting the battery materials to create molten glass will cause the metal materials and organic compounds to be easily separated, and that as a result, intermingling thereof with recycling materials will be suppressed.

[2] The production method according to [1], in which the battery material includes at least one selected from a group consisting of a cathode, an anode, and a bipolar electrode.

Any battery material may be used, as long as it contains at least one type selected from the group consisting of metal materials and organic compounds. Conceivable battery materials include, for example, cathodes, anodes, bipolar electrodes, and the like.

[3] The production method according to [1] or [2], in which the battery material includes a phosphate, the production method further including
(e) obtaining glass powder by pulverizing the glass material; and
(f) subjecting the glass powder to thermal treatment.

It is anticipated that when the battery material contains phosphoric acid, trace amounts of foreign matter (e.g., chromium and so forth) will react with the phosphoric acid and be rendered harmless.

[4] The production method according to [3], in which the battery material contains an olivine phosphate compound.

[5] The production method according to any one of [1] to [4], in which the (b) includes
(b1) adding a flux to the battery material,
(b2) holding the battery material at a temperature of 700° C. or higher and 900° C. or lower, and
(b3) holding the battery material at a temperature of 1000° C. or higher and 1100° C. or lower,
in this order.

Adding the flux to the battery material promotes melting of the battery material. It is anticipated that maintaining the battery materials at a temperature of 700° C. or higher and 900° C. or lower will promote separation of metal materials, and maintaining the battery materials at a temperature of 1000° C. or higher and 1100° C. or lower will promote separation of organic compounds.

An embodiment of the present disclosure (hereinafter may be abbreviated to “the present embodiment”) will be described below. Note, however, that the present embodiment does not limit the technical scope of the present disclosure. The present embodiment is exemplary in all respects. The present embodiment is non-limiting. The technical scope of the present disclosure includes all modifications that fall within the meaning and scope equivalent to the claims. For example, it is planned from the beginning to extract optional configurations from the present embodiment and the Examples, and optionally combine these configurations.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic flowchart of a production method of recycled materials according to an embodiment;

FIG. 2 is a schematic flowchart of a production method of recycled materials in Examples 3 to 5; and

FIG. 3 is a table showing production conditions and experiment results of the recycled materials in the Examples.

### DETAILED DESCRIPTION OF EMBODIMENTS

### Terms and Phrases

“Comprise,” “include,” “have,” and variations thereof are open ended expressions. A configuration expressed as open ended may or may not further include additional elements in addition to essential elements.

“Recycling materials” refers to all materials that can be recovered from battery materials. The recycling materials are not limited to active materials. For example, substrates (e.g., aluminum foil, copper foil, etc.) are also recycling materials. Electrode composite materials are also recycling materials. Applications for recycling materials are not limited to batteries. The recycling materials may be used in applications other than batteries.

“Battery materials” refers to any material, member, or part contained in a battery. The battery material may be a single material or a mixture (e.g., a composite material or the like). The battery material may be, for example, a complex (e.g., electrode or the like), a molded article, or the like.

“Black mass” refers to a concentrate obtained by going through a process of thermal treating (roasting) of batteries, crushing the roasted material, sorting the crushed material, and so forth. Black mass contains metals such as, for example, nickel, cobalt, manganese, iron, and so forth, as well as organic compounds. The metal can be, for example, a component derived from cathode active materials or current collector foil. The organic compound can be, for example, a component derived from a conductive material or a binder.

### Production Method of Recycled Material

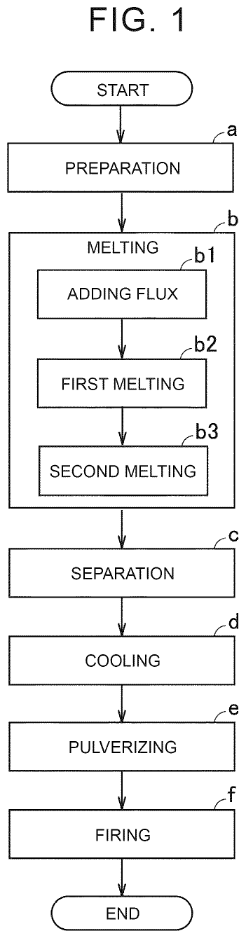

FIG. 1 is a schematic flowchart of a production method of recycled materials according to the present embodiment. Hereinafter, the “production method of a recycled material according to the present embodiment” may be referred to simply as “present production method”. The present production method includes “(a) preparing”, “(b) melting”, “(c) separating”, and “(d) cooling”. The present production method may further include, for example, “(e) pulverizing”, “(f) firing”, and so forth. In the present production method, “(b) melting” may further include, for example, “(b1) adding flux”, “(b2) first melting”, “(b3) second melting”, and so forth.

### (a) Preparation

The present production method includes preparing battery material.

Any battery material may be used. The battery material may include, for example, at least one type selected from a group consisting of cathodes, anodes, and bipolar electrodes. The battery material may include at least one type of black mass selected from the group consisting of cathodes, anodes, and bipolar electrodes. The battery material can be prepared by any method. For example, various battery materials may be recovered by disassembling used batteries, defective batteries, or the like. For example, black mass may be formed by subjecting used batteries, defective batteries, or the like, to various types of treatment, such as roasting or the like.

Cathodes include cathode current collector foil and cathode composite material. The cathode current collector foil may contain, for example, aluminum or the like. The cathode composite material is attached to the cathode current collector foil. The cathode composite material includes, for example, a cathode active material, a conductive material, a binder, and so forth. The cathode active material may contain, for example, lithium nickel complex oxide (LNO), lithium-containing complex phosphate, or the like. The conductive material may include, for example, graphite, carbon black, carbon fiber, carbon nanotubes, graphene flakes, or the like. The binder may include, for example, polyvinylidene fluoride or the like.

LNO may have, for example, a crystal structure belonging to the space group R-3m. The space group is identified by powder X-ray diffraction (XRD) measurement. LNO may have, for example, a composition represented by the following general formula.

Li₁₋ₐNiₓM₁₋ₓO₂

In the formula, the relations of −0.5≤a≤0.5 and 0≤x≤1 may be satisfied. For example, M may include at least one type selected from a group consisting of Co, Mn, and Al.

LNO may be represented by, for example, the following general formula. A compound represented by the following general formula may also be referred to as “NCM”.

Li₁₋ₐNiₓCo_{y}Mn_{z}O₂

In the formula, the relations of −0.5≤a≤0.5, 0<x<1, 0<y<1, 0<z<1, and x+y+z=1 may be satisfied.

The lithium-containing complex phosphate contains at least one type selected from a group consisting of nickel, cobalt, manganese, and iron. When the battery material contains phosphoric acid, it is anticipated that trace amounts of foreign matter that can react with phosphoric acid will be rendered harmless. Examples of lithium-containing complex phosphates include olivine phosphate compounds.

The olivine phosphate compound may have, for example, a crystal structure belonging to the space group Pnma. The olivine phosphate compound may include, for example, lithium iron phosphate (LFP), lithium manganese phosphate (LMP), or the like. In the LMP, a portion of the manganese (Mn) may be substituted with iron (Fe). An Fe-substituted form of the LMP is also referred to as lithium manganese iron phosphate (LMFP). The LMP may have a composition represented by the following general formula, for example.

Li₁₋ₐMn₁₋ₓFeₓPO₄

For example, the relations −0.5≤a≤0.5 and 0≤x≤1 may be satisfied.

Anodes include anode current collector foil and anode composite material. The anode current collector foil may contain, for example, copper or the like. The anode composite material is attached to the anode current collector foil. The anode composite material includes, for example, an anode active material, a conductive material, a binder, and so forth. The anode active material may contain, for example, graphite, soft carbon, hard carbon, silicon, silicon oxide, silicon-carbon composite material (Si/C material), lithium titanium composite oxide, or the like. The conductive material is the same as that of the cathode composite material. The binder may include, for example, carboxymethyl cellulose, styrene butadiene rubber, and the like.

The bipolar electrode includes a cathode composite material, a cathode current collector foil, an anode current collector foil, and an anode composite material. For example, an adhesive may bond the cathode current collector foil and the anode current collector foil together. The cathode composite material and the anode composite material are in a front-rear relation.

### (b) Melting

The present production method includes melting the battery materials to create a molten glass.

Melting temperature and melting time (holding time) may be adjusted as appropriate, in accordance with the battery material. The melting temperature may be, for example, 600° C. or higher and 1100° C. or lower. The melting time may be, for example, 60 minutes or more and 120 minutes or less.

The melting atmosphere may be adjusted as appropriate in accordance with the battery material. The melting atmosphere may be, for example, a nitrogen atmosphere or an ambient atmosphere.

### (b1) Addition of Flux

The present production method may include, for example, adding a flux to the battery materials. The flux has a melting point that is lower than the melting temperature. The flux may be, for example, a hydroxide, a chloride, a carbonate, or the like, containing at least one type of alkali metal selected from a group consisting of lithium, sodium, and potassium. Examples of the flux include lithium hydroxide, sodium hydroxide, potassium hydroxide, lithium chloride, sodium chloride, potassium chloride, lithium carbonate, sodium carbonate, potassium carbonate, and so forth.

The amount of flux added may be adjusted as appropriate in accordance with the battery material. The amount of flux that is added may be, for example, 1% or more and 20% or less in mass fraction relative to the battery material.

### (b2) First Melting and (b3) Second Melting

In the present production method, for example, two stages of melting may be carried out. That is to say, first melting and second melting may be carried out, in this order. The second melting may be at a higher temperature than the first melting. A first melting temperature may be, for example, 600° C. or higher and 900° C. or lower, 700° C. or higher and 900° C. or lower, or 700° C. or higher and 800° C. or lower. A second melting temperature may be, for example, 900° C. or higher and 1100° C. or lower, or 1000° C. or higher and 1100° C. or lower.

The first melting and the second melting may be carried out (held) for the same amount of time, or may be carried out over different amounts of time. For example, the first melting and the second melting may be carried out for 60 minutes each. For example, the first melting and the second melting may be carried out for 30 minutes and 90 minutes respectively, or carried out for 90 minutes and 30 minutes respectively.

### (c) Separation

The present production method includes separating the molten glass from at least one type selected from a group consisting of a metal material and an organic compound, contained in the battery material.

The metal material can be derived from a cathode current collector foil, an anode current collector foil, and so forth. The organic compound can be derived from a conductive material, a binder, or the like.

Any separation method may be used. For example, the liquid component (molten glass) and the solid component may be separated by filtration. For example, an intended liquid component (molten glass) may be separated from a liquid component containing foreign matter by specific gravity separation.

When the step (b) includes the step (b2) and the step (b3), this step may be carried out after each of the steps. For example, after the liquid component and the solid component are separated following step (b2), the separated solid component may be melted in step (b3) to separate the liquid component and the solid component therefrom.

### (d) Cooling

The present production method includes cooling the molten glass to create a glass material.

The cooling may be carried out, for example, at a predetermined cooling rate, or simply allowing the material to cool (natural cooling), or by rapidly cooling the material in the open air.

For example, the glass material may be used as a recycled material as it is (direct recycling). For example, various types of recycled materials may be produced by processing glass materials, which will be described later.

### (e) Pulverizing

The present production method may include obtaining glass powder by pulverizing the glass material.

Any pulverizing method may be used. For example, the pulverizing may be carried out using a ball mill or a mortar.

### (f) Firing

The present production method may include subjecting glass powder to thermal treatment. This step can be applied, for example, when producing a cathode active material as a recycled material.

The thermal treatment temperature and thermal treatment time may be adjusted as appropriate in accordance with the battery material (cathode active material). The thermal treatment temperature may be, for example, 200° C. or higher and 700° C. or lower. The thermal treatment time may be, for example, 1 hour or more and 6 hours or less.

The thermal treatment atmosphere may be adjusted as appropriate in accordance with the battery material (cathode active material). The thermal treatment atmosphere may be, for example, a nitrogen atmosphere or the ambient atmosphere.

The present production method is anticipated to facilitate separation of metal materials and organic compounds, thereby suppression intermingling thereof into recycled materials. The amount (mass fraction) of the mixed metal material in the recycled material that is obtained can be measured by inductively coupled plasma atomic emission spectroscopy (ICP-AES). The amount (mass fraction) of the organic compound (carbon) that is intermingled can be measured by a carbon-sulfur analyzer (CS analyzer).

### Production of Recycled Material

### No. 1, 2

A black mass containing only cathode material following roasting, was prepared as a battery material. The cathode material includes each of aluminum foil as a cathode current collector foil and LMFP as a cathode active material. The black mass was fired at 400° C. for 2 hours. The firing was carried out in an ambient atmosphere for No. 1 and in a nitrogen atmosphere for No. 2.

The fired product was pulverized in a ball mill to obtain a powder.

A carbon source was added to the powder, and the powder was fired in a nitrogen atmosphere, thereby producing a recycled material (recycled LMFP).

### Nos. 3 to 5

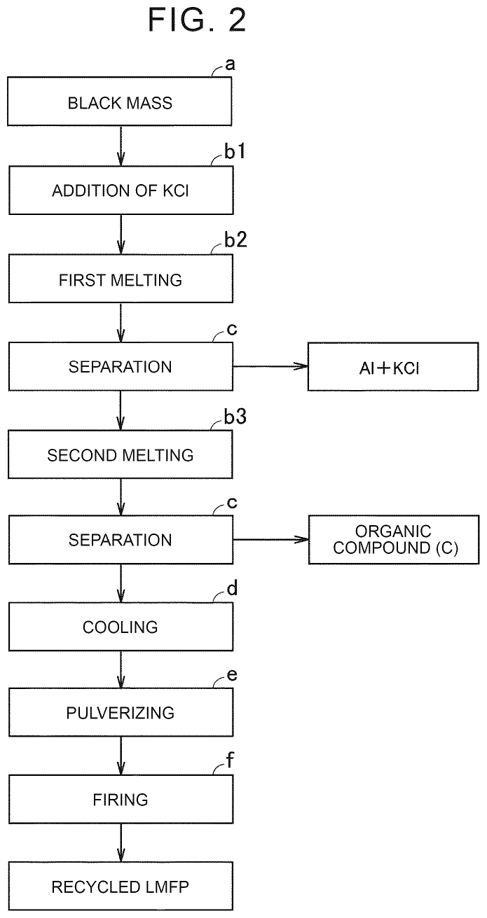

FIG. 2 is a schematic flowchart of the production method of recycled material (recycled LMFP) in Examples 3 to 5. Each of the steps was carried out below according to FIG. 2.

### (a) Preparation

The above-described black mass was prepared.

### (b) Melting and (c) Separation

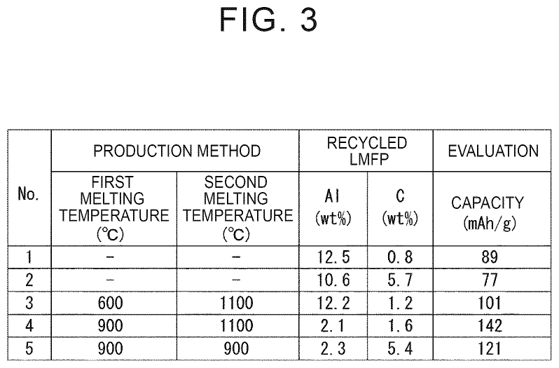

Potassium chloride was added to the black mass at a mass fraction of 10%. A saggar, in which the mixture was loaded, was placed in a kiln. Melting was carried out under a nitrogen atmosphere, by the following procedures. First, the temperature is increased at a temperature increasing rate of 10 ° C./min until the temperature inside the kiln reaches the temperature shown in FIG. 3 (first melting temperature). The temperature inside the kiln, shown in FIG. 3, is held for 1 hour. After holding for 1 hour, the saggar is removed from the kiln and the liquid component is removed. The liquid component can contain aluminum and potassium chloride. The saggar is then placed into the kiln again. The temperature is increased at a temperature increasing rate of 5 ° C./min until the temperature inside the kiln reaches the temperature shown in FIG. 3 (second melting temperature). The temperature inside the kiln, shown in FIG. 3, is held for 1 hour. After holding the temperature for 1 hour, the saggar is removed from the kiln, and solid components, floating on the surface thereof, are removed to obtain molten glass. The solid components can include organic compounds.

### (d) Cooling

The molten glass was allowed to cool naturally to 400° C. to obtain a glass material.

### (e) Pulverizing

The glass material was pulverized in a ball mill to obtain glass powder.

### (f) Firing

A carbon source was added to the glass powder, and firing was performed under a nitrogen atmosphere, thereby producing a recycled material (recycled LMFP).

### Fabrication of Coin Cell

The cathode active material, a conductive material (acetylene black), and a binder (PVdF) were mixed to form a mixture. The mixing ratio (mass ratio) was “cathode active material/conductive material/binder=92/5/3”. The mixture was dispersed in a solvent (N-methyl-2-pyrrolidone) to form a paste. The solid content concentration of the paste was 50% by mass fraction. The paste was applied to the surface of aluminum foil and dried, thereby forming a cathode layer. The density of the cathode layer was adjusted to 1.8 g/cm³ by roll pressing to form a cathode blank. The cathode blank was subjected to vacuum drying treatment at 120° C. for 12 hours. After drying, a disc sample (14 mm in diameter) was obtained from the cathode blank by punching.

A coin cell was assembled in a glove box. The cell configuration is as follows.
Working electrode: disc sample (cathode)
Counter electrode: Li foil
Separator: porous polymer membrane
Electrolyte solution: “Ethylene carbonate/dimethyl carbonate=3/7 (volume ratio)”, LiPF₆(1 mol/L)

### Evaluation

### Measurement

For each No., a powder (glass powder) was prepared before adding a carbon source. The amount of aluminum (mass fraction) contained in each powder was measured. The amount of carbon (mass fraction) contained in each powder was measured using a CS meter. The results thereof are shown in FIG. 3. Note that the aluminum content was evaluated based on No. 1, and the carbon content was evaluated based on No. 2, to see whether reduction thereof was achieved.

### Capacity

The capacity (mAh/g) of each coin cell was measured. The results thereof are shown in FIG. 3.

### Results

As shown in FIG. 3, when the production conditions of the present disclosure are satisfied, the amount of foreign matter tends to decrease. Also, Nos. 3 to 5 have larger capacities than Nos. 1 and 2.

What is claimed is:

1. A production method of a recycled material, the production method comprising:
(a) preparing a battery material;
(b) melting the battery material to create molten glass;
(c) separating the molten glass from at least one selected from a group consisting of a metal material and an organic compound, contained in the battery material; and
(d) cooling the molten glass to create a glass material.

2. The production method according to claim 1, wherein the battery material includes at least one selected from a group consisting of a cathode, an anode, and a bipolar electrode.

3. The production method according to claim 1, wherein the battery material includes a phosphate, the production method further comprising:
(e) obtaining glass powder by pulverizing the glass material, and
(f) subjecting the glass powder to thermal treatment.

4. The production method according to claim 3, wherein the battery material includes an olivine phosphate compound.

5. The production method according to claim 1, wherein
the (b) includes
(b1) adding a flux to the battery material,
(b2) holding the battery material at a temperature of 700 ° C. or higher and 900 ° C. or lower, and
(b3) holding the battery material at a temperature of 1000 ° C. or higher and 1100 ° C. or lower, in this order.
